(19) United States
(12) Patent Application Publication
(10) Pub. No.: US 2025/0074249 A1
(43) Pub. Date: Mar. 6, 2025

(54) APPARATUS AND METHOD FOR DETECTING A FIRST VENTING EVENT OF A BATTERY, SYSTEM AND VEHICLE

(71) Applicant: Infineon Technologies AG, Neubiberg (DE)

(72) Inventors: Dan-Alexandru MOCANU, Bucharest (RO); Christoph STEINER, St. Margarethen a. d. Raab (AT)

(21) Appl. No.: 18/807,419

(22) Filed: Aug. 16, 2024

(30) Foreign Application Priority Data
Sep. 5, 2023 (DE) 102023123905.8

(51) Int. Cl. B60L 58/10; G01N 25/18; H01M 10/42

(52) U.S. Cl. CPC B60L 58/10; G01N 25/18; H01M 10/4285; B60L 2250/00

(57) ABSTRACT

An apparatus for detecting a first venting event of a battery is provided. The apparatus includes interface circuitry configured to receive a measurement signal indicative of a thermal conductivity of a gas atmosphere in the battery. Additionally, the apparatus includes processing circuitry configured to determine occurrence of the first venting based on the measurement signal.

### CROSS-REFERENCE TO RELATED APPLICATION

This application claims priority to Germany Patent Application No. 102023123905.8 filed on Sep. 5, 2023, the content of which is incorporated by reference herein in its entirety.

### TECHNICAL FIELD

The present disclosure relates to detection of first venting events of batteries. In particular, examples of the present disclosure relate to an apparatus and a method for detecting a first venting event of a battery, a system comprising the apparatus and a vehicle comprising the system.

### BACKGROUND

Batteries such as batteries for electric vehicles can have a thermal runaway event. Thermal runaway events may cause critical situations. Early detection of thermal runaway events is important.

Hence, there may be a demand for early detection of potential thermal runaway events.

### SUMMARY

This demand is met by the subject-matter of the independent claims. Advantageous implementations are addressed by the dependent claims.

According to a first aspect, the present disclosure provides an apparatus for detecting a first venting event of a battery. The apparatus includes interface circuitry configured to receive a measurement signal indicative of a thermal conductivity of a gas atmosphere in the battery. Additionally, the apparatus includes processing circuitry configured to determine occurrence of the first venting based on the measurement signal.

According to a second aspect, the present disclosure provides a system including an apparatus for detecting a first venting event of a battery according to the first aspect. The system further includes a thermal conductivity sensor configured to measure the thermal conductivity of the gas atmosphere in the battery and to generate the measurement signal.

According to a third aspect, the present disclosure provides a vehicle including a system according to the second aspect and the battery.

According to a fourth aspect, the present disclosure provides a method for detecting a first venting event of a battery. The method includes receiving a measurement signal indicative of a thermal conductivity of a gas atmosphere in the battery. Additionally, the method includes determining occurrence of the first venting based on the measurement signal.

A thermal runaway event of a battery follows one or more gas venting events. The venting of the gases affects the thermal conductivity of the gas atmosphere in the battery. The thermal conductivity of a gas atmosphere can be measured. Accordingly, a measurement signal indicative of the thermal conductivity of the gas atmosphere in the battery allows to determine occurrence of the first venting event of the battery and, hence, early detection of a thermal runaway event.

### BRIEF DESCRIPTION OF THE DRAWINGS

Some examples of apparatuses and/or methods will be described in the following by way of example only, and with reference to the accompanying figures, in which

FIG. 1 schematically illustrates an example apparatus for detecting a first venting event of a battery;

FIG. 2 illustrates example temporal courses of thermal conductivity;

FIG. 3 schematically illustrates a first example signal processing flow;

FIG. 4 schematically illustrates a second example signal processing flow;

FIG. 5 schematically illustrates an example thermal conductivity sensor;

FIG. 6 schematically illustrates an example vehicle; and

FIG. 7 illustrates a flowchart of an example method for detecting a first venting event of a battery.

### DETAILED DESCRIPTION

Some examples are now described in more detail with reference to the enclosed figures. However, other possible examples are not limited to the features of these implementations described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, e.g., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

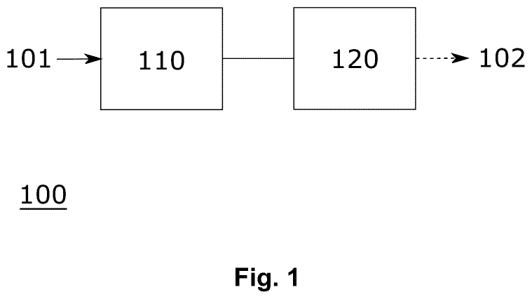

FIG. 1 schematically illustrates an apparatus 100 for detecting a first venting event of a battery. A battery comprises one or more battery cells and electronics. The at least one battery cell of the battery is arranged in a housing of the battery together with the batterie's electronics. In case the battery comprises a plurality of battery cells, each battery cell may be housed, and the housed cells may be arranged in a battery cell array. The battery cell array and the electronics are arranged within the housing of the battery. A battery comprising a plurality of battery cells may also be referred to as battery pack.

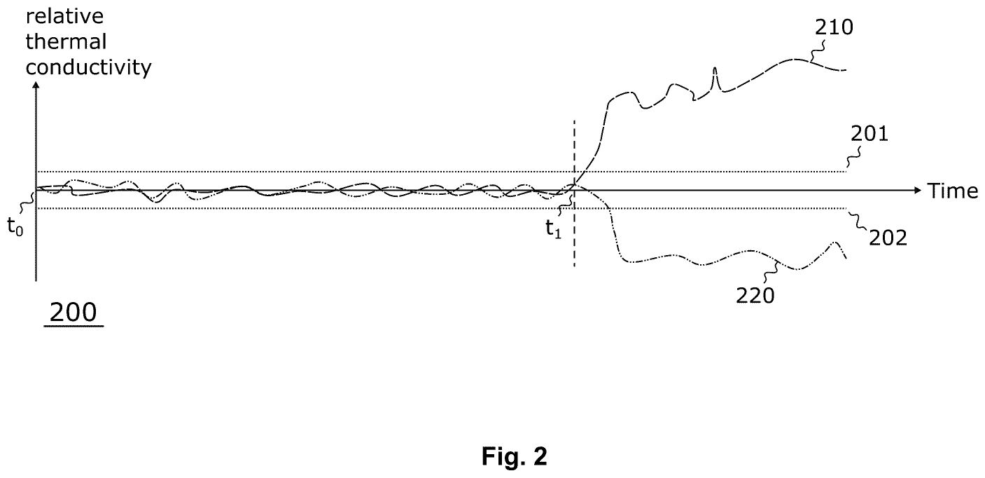

A thermal runaway event of a battery follows one or gas venting events. During a venting event, one or more gases such as electrolytes, water (H₂O), carbon dioxide (CO₂), carbon monoxide (CO), ethane (C₂H₆), hydrogen (H₂) or ethene (C₂H₄) are vented from the one or more battery cells into the housing of the battery in a short period of time. However, it is to be noted that the present disclosure is not limited to the foregoing example list of gases. Other or additional gases may be vented (e.g., depending on the type of battery). The first venting event occurs prior to the thermal runaway of the battery and, hence, allows early detection of the battery's thermal runaway (e.g., battery failure). The venting of the gases affects the thermal conductivity of the gas atmosphere in the battery. This is exemplarily illustrated in FIG. 2. FIG. 2 illustrates a diagram 200 showing two example temporal courses of the relative thermal conductivity of the gas atmosphere in a battery. The abscissa denotes time. The ordinate denotes relative thermal conductivity.

The battery operates normal from a time instant t₀ to a time instant t₁. As can be seen from FIG. 2, the temporal courses 210 and 220 of the relative thermal conductivity of the gas atmosphere in the battery do not vary significantly from the time instant t₀ to the time instant t₁. The variations are rather slow and are caused dominantly by environmental variations (e.g., pressure, temperature and humidity). At the time instant t₁, a first venting event occurs. The relative temporal courses 210 and 220 change suddenly. As indicated by the two temporal courses 210 and 220, the thermal conductivity may change positively or negatively due to the first venting event. In other words, the thermal conductivity of the gas atmosphere in the battery may increase or decrease significantly in a short period of time due to the first venting event. Hence, a sudden change of the thermal conductivity of the gas atmosphere in the battery is a strong indication that a first venting event, e.g., an anomaly in the battery occurred. The thermal conductivity of a gas atmosphere can be measured. For example, one or more (thermal conductivity) sensor configured to measure the thermal conductivity of the gas atmosphere in the battery may be arranged within the battery (e.g., inside the housing of the battery).

Returning back to FIG. 1, the apparatus 100 makes use of the above-described relation between the occurrence of a first venting and the sudden change of the thermal conductivity of the gas atmosphere in the battery for detecting a first venting event of a battery.

The apparatus 100 comprises interface circuitry 110 configured to receive a measurement signal 101 indicative of a thermal conductivity of a gas atmosphere in the battery. For example, the measurement signal 101 may be generated by one or more thermal conductivity sensor arranged within the battery. The measurement signal 101 may be an analog signal or a digital signal. The interface circuitry may, e.g., be configured to receive the measurement signal 101 directly from the one or more thermal conductivity sensor or from an intermediate circuitry coupled between the apparatus 100 and the one or more thermal conductivity sensor (e.g., circuitry for buffering or pre-processing the measurement signal 101).

The apparatus 100 further comprises processing circuitry 120 coupled to the interface circuitry 110. For example, the processing circuitry 120 may be a single dedicated processor, a single shared processor, or a plurality of individual processors, some of which or all of which may be shared, a digital signal processor (DSP) hardware, an application specific integrated circuit (ASIC), a neuromorphic processor or a field programmable gate array (FPGA). The processing circuitry 120 may optionally be coupled to, e.g., read only memory (ROM) for storing software, random access memory (RAM) and/or non-volatile memory. The processing circuitry 120 is configured to process the measurement signal 101.

In particular, the processing circuitry 120 is configured to determine occurrence of the first venting based on the measurement signal 101. The processing circuitry 120 may, e.g., output an output signal or output data 102 indicating whether occurrence of the of the first venting is determined or not. As described above, the occurrence of the first venting causes sudden change of the thermal conductivity of the gas atmosphere in the battery. Hence, the temporal course of the thermal conductivity of the gas atmosphere in the battery as indicated by the measurement signal 101 allows to detect the occurrence of a first venting event of the battery. Detection of a first venting event of the battery allows for early detection of a thermal runaway event.

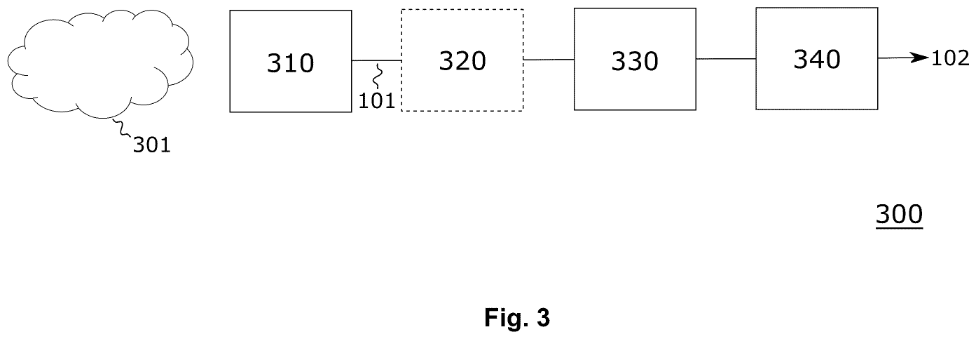

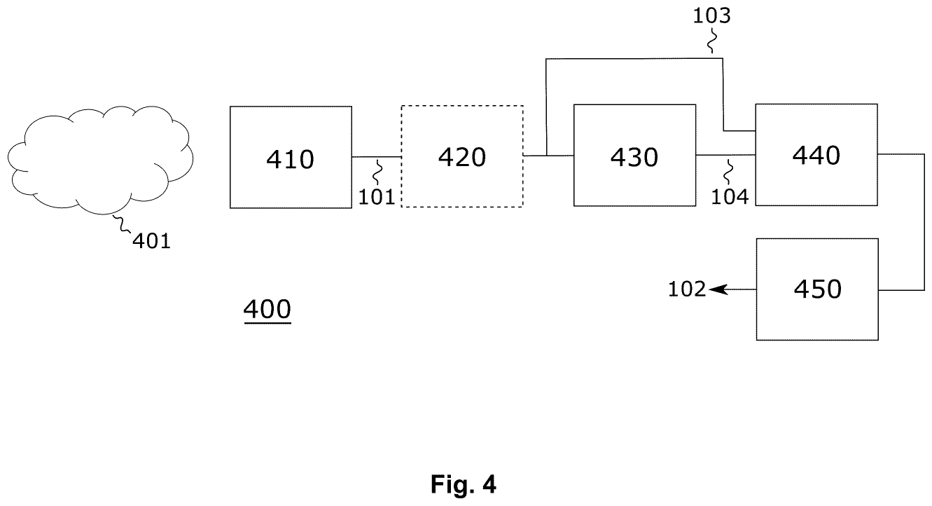

For determining occurrence of the first venting event, the processing circuitry 120 may, e.g., be configured to determine a variation over time of the thermal conductivity of the gas atmosphere based on the measurement signal 101. The variation over time describes how the measurement values represented by the measurement signal change or fluctuate as time progresses. Various methods may be used for determining the variation over time of the thermal conductivity. Two examples will be described later with reference to FIGS. 3 and 4. However, it is to be noted that the present disclosure is not limited to these examples.

Furthermore, for determining occurrence of the first venting event, the processing circuitry 120 may be configured to determine that the first venting event occurred if the variation over time of the thermal conductivity of the gas atmosphere satisfies a criterion. As described above, the thermal conductivity of the gas atmosphere in the battery changes slowly over time in case the battery operates normally. However, a sudden change in thermal conductivity of the gas atmosphere in the battery occurs in case of a first venting event. Accordingly, the variation over time of the thermal conductivity of the gas atmosphere is a suitable quantity for determining occurrence of the first venting event. The criterion for determining that the first venting event occurred may be manifold. For example, the processing circuitry 120 may be configured to determine that the first venting event occurred if the variation over time of the thermal conductivity of the gas atmosphere changes by more than a threshold value.

This is also indicated in FIG. 2 showing two thresholds 201 and 202. From the time instant t₀ to the time instant t₁, the two courses 210 and 220 are within the thresholds 201 and 202. However, at the time instant t₁, the two courses 210 and 220 change suddenly and significantly such that they exceed the thresholds 201 and 202.

As described above, various approaches may be used for determining the variation over time of the thermal conductivity. FIG. 3 schematically illustrates a first example signal processing flow 300 using the standard deviation of measurement values represented by the measurement signal 101 as the variation over time of the thermal conductivity of the gas atmosphere.

As indicated in FIG. 3, the thermal conductivity of a gas atmosphere 301 in the battery is measured in measurement step 310. For example, one or more thermal conductivity sensor arranged within the battery may be used for measuring the thermal conductivity of the gas atmosphere 301. The measurement signal 101 is the result of the measurement step 310. Due to the proposed signal processing, one or more uncalibrated and uncompensated thermal conductivity sensor may be used for measuring the thermal conductivity of the gas atmosphere 301.

The standard deviation of a number of measurement values represented by the measurement signal 101 is determined in a subsequent step 330 as the variation over time of the thermal conductivity of the gas atmosphere 301. For example, for determining occurrence of the first venting event, the processing circuitry 120 may be configured to determine the standard deviation of a number of measurement values represented by the measurement signal as the variation over time of the thermal conductivity of the gas atmosphere 301. The specific number of measurement values may depend on various properties such as the type of thermal conductivity sensor used or the design of the battery. However, the number of measurement values may cover a measurement period of at least 100 milliseconds. Further, the number of measurement values may cover a measurement period of not more than 10 seconds. As the thermal conductivity changes rapidly in case of a first venting event, rather short measurement periods as exemplarily described in the foregoing are sufficient.

For determining whether the first venting event occurred or not, a threshold value is used as criterion in a subsequent step 340. For example, the processing circuitry 120 may be configured to determine that the first venting event occurred if the standard deviation of the number of measurement values (as determined in step 330) is larger/greater than a threshold value. As described above, the thermal conductivity of the gas atmosphere in the battery changes slowly over time in case the battery operates normally. However, a sudden change in thermal conductivity of the gas atmosphere in the battery occurs in case of a first venting event. Hence, comparing the standard deviation of the number of measurement values to the threshold value allows to distinguish between normal operation of the battery and a first venting event. The output signal or output data 102 indicating whether occurrence of the of the first venting is determined or not is the result of the step 340.

Optionally, the measurement signal 101 may be subject to signal conditioning processing such as signal amplification, signal filtering or analog-to-digital conversion in a step 320, which precedes step 330. In other words, the processing circuitry 120 may be configured to perform signal conditioning processing on the measurement signal 101 prior to determining the variation over time of the thermal conductivity of the gas atmosphere. The signal conditioning processing may allow to enhance the signal characteristics (properties) of the measurement signal 101 for the subsequent signal analysis.

An alternative second example signal processing flow 400 using a relative measurement of the current thermal conductivity and an effective “ambient thermal conductivity” for determining the variation over time of the thermal conductivity of the gas atmosphere is schematically illustrated in FIG. 4.

Like in the example of FIG. 3, the thermal conductivity of a gas atmosphere 401 in the battery is measured in measurement step 410. The measurement signal 101 is the result of the measurement step 410. Again, one or more uncalibrated and uncompensated thermal conductivity sensor may be used for measuring the thermal conductivity of the gas atmosphere 401.

An auxiliary conductivity value 104 representing a long-term thermal conductivity of the gas atmosphere is determined based on the measurement signal 101 in a subsequent step 430. For example, for determining the variation over time of the thermal conductivity of the gas atmosphere, the processing circuitry 120 may be configured to filter the measurement signal 101 to obtain the auxiliary conductivity value 104 representing the long-term thermal conductivity of the gas atmosphere 401. The auxiliary conductivity value 104 effectively indicates the average thermal conductivity of the gas atmosphere 401 in the past. In other words, the auxiliary conductivity value 104 effectively indicates the expected thermal conductivity of the gas atmosphere 401 in case no first venting event occurs. For example, for obtaining the auxiliary conductivity value 104, the processing circuitry 120 may be configured to average measurement values represented by the measurement signal 101. The specific number of measurement values may depend on various properties such as the type of thermal conductivity sensor used or the design of the battery. However, the number of averaged measurement values may cover a measurement period of at least 30 seconds, 1 minute, 2 minutes, 5 minutes or 10 minutes. Even in case some of the averaged measurement values already relate to the first venting event, their number is small compared to the number of averaged measurement values before the first venting event. Accordingly, the auxiliary conductivity value 104 is not (significantly) influenced by the first venting event. The auxiliary conductivity value 104 is updated based on the measurement signal 101 as time progresses.

In a subsequent step 440, a difference value indicating a difference between a measurement value 103 represented by the measurement signal 101 and the auxiliary conductivity value 104 is determined. Further, a quotient of the difference value and the auxiliary conductivity value 104 is determined as the variation over time of the thermal conductivity of the gas atmosphere 401. The processing of step 440 may be summarized by the following mathematical expression:

$$V = \frac{TC - TC 0}{TC 0} \qquad ( 1 )$$

with V denoting the variation over time of the thermal conductivity of the gas atmosphere 401, TC denoting the measurement value 103 represented by the measurement signal 101 and TC0 denoting the auxiliary conductivity value 104.

The processing circuitry 120 may be configured to perform the processing of step 440 for determining the variation over time of the thermal conductivity of the gas atmosphere 401.

Like in the example of FIG. 3, a threshold value is used as criterion in a subsequent step 450 for determining whether a first venting event occurred or not. For example, the processing circuitry 120 may be configured to determine that the first venting event occurred if the quotient determined (in step 440) as the variation over time of the thermal conductivity of the gas atmosphere 401 is larger/greater than a threshold value. As described above, the thermal conductivity of the gas atmosphere in the battery changes slowly over time in case the battery operates normally. This is reflected by the auxiliary conductivity value 104, which changes only slowly (e.g., on a minute time scale). A sudden change in thermal conductivity of the gas atmosphere 401 in the battery occurs in case of a first venting event. This is reflected by the measurement value 103 represented by the measurement signal 101, which changes instantaneously (e.g., on a second time scale). Accordingly, the quotient changes instantaneously and significantly in case of a first venting event. Hence, comparing the quotient determined as the variation over time of the thermal conductivity of the gas atmosphere 401 to the threshold value allows to distinguish between normal operation of the battery and a first venting event. The output signal or output data 102 indicating whether occurrence of the of the first venting is determined or not is the result of the step 450.

Optionally, the measurement signal 101 may be subject to signal conditioning processing such as signal amplification, signal filtering or analog-to-digital conversion in a step 420, which precedes step 430. In other words, the processing circuitry 120 may be configured to perform signal conditioning processing on the measurement signal 101 prior to determining the variation over time of the thermal conductivity of the gas atmosphere. The signal conditioning processing may allow to enhance the signal characteristics (properties) of the measurement signal 101 for the subsequent signal analysis.

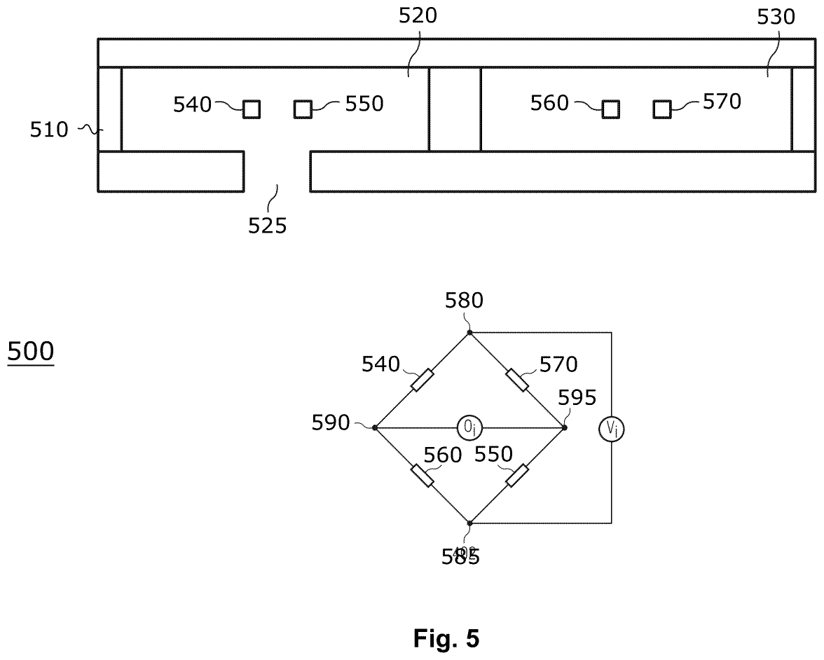

An example thermal conductivity sensor 500 is illustrated in FIG. 5. As illustrated in the upper part of FIG. 5, the thermal conductivity sensor 500 comprises a housing 510. Two cavities 520 and 530 are formed in housing 510. The cavity 520 is open, e.g., the cavity 520 is accessible from outside thermal conductivity sensor 500 via the opening 525 in the housing 510. Accordingly, a gas to be measured such as gas from a gas atmosphere in a battery may enter the cavity 520. The cavity 530 is sealed, e.g., the cavity 530 is not accessible from outside the thermal conductivity sensor 500. The cavity 530 serves as a reference cavity and is filled with a reference gas (e.g., air, oxygen or nitrogen).

Two piezoresistive wires 540, 550 and 560, 570 are arranged in each of the cavities 520 and 530. The piezoresistive wires 540, 550, 560 and 570 are coupled to form a Wheatstone bridge as illustrated in the lower part of FIG. 5. An electric voltage Vi is applied to the piezoresistive wires 540, 550, 560 and 570 via the nodes 580 and 585 of the Wheatstone bridge to heat the piezoresistive wires 540, 550, 560 and 570.

Changes in the thermal conductivity of the gas entering the cavity 520 will result in temperature changes of the resistors 540 and 550 and therefore a resistance change which is measured as measurement voltage O; between the nodes 590 and 595 of the Wheatstone bridge. The piezoresistive wires 560 and 570 in the reference chamber 530 compensate for drift due temperature fluctuations. The measurement voltage Oᵢ of the Wheatstone bridge may be used as the measurement signal 101 described above.

It is to be noted that the present disclosure is not limited to the thermal conductivity sensor 500. Any other type of thermal conductivity sensor may be used as well for generating a measurement signal indicative of a thermal conductivity of a gas atmosphere in a battery. In particular, thermal conductivity sensors using only a single resistive wire and/or only a single cavity (e.g., no reference cavity) may be used. The present disclosure does not require a specific structure of the thermal conductivity sensor. In other words, any type of thermal conductivity sensor may be used. Due to the proposed signal processing, uncalibrated and uncompensated thermal conductivity sensor may be used for measuring the thermal conductivity of the gas atmosphere in the battery.

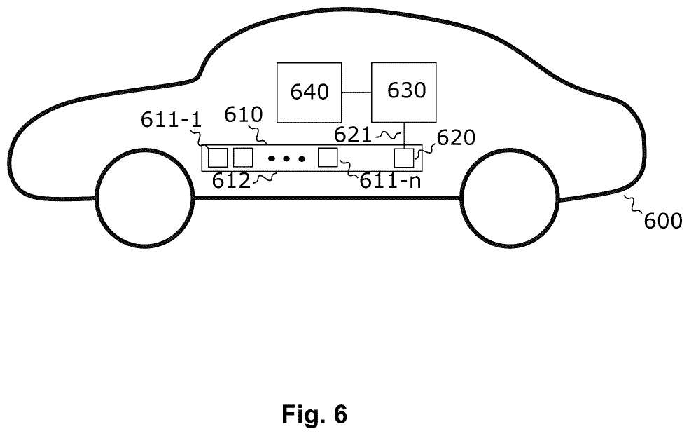

An application using the proposed technology for detecting a first venting event of a battery is illustrated in FIG. 6. FIG. 6 illustrates a vehicle 600. Although the vehicle 600 is depicted as a car in the example of FIG. 6, it is to be noted that the present disclosure is not limited thereto. In general, a vehicle can be understood as a device (system) comprising one or more engine (e.g., an electric engine) for propulsion. The vehicle may comprise various means driven by the one or more engine for propulsion of the vehicle such as one or more tire, one or more rotor and/or one or more propeller. The vehicle 600 can be both a passenger vehicle and a commercial vehicle. For example, the vehicle 600 may be a car (automobile) as depicted in FIG. 6, a truck, a motorcycle, a tractor, an aerial vehicle (such as an airplane or a helicopter) or a naval vehicle (such as a boat).

The vehicle 600 comprises a battery 610. For example, the battery 610 may be configured to supply electrical energy to at least one of the one or more engine of the vehicle 600. In the example of FIG. 6, the battery 610 comprises a plurality of battery cells 611-1, . . . , 611-n (with n≥2). The battery cells 611-1, . . . , 611-n are arranged as a cell array within a housing 612 of the battery 610. Further arranged within the housing 612 is a thermal conductivity sensor 620.

The thermal conductivity sensor 620 is configured to measure the thermal conductivity of the gas atmosphere in the battery 610 and to generate a corresponding measurement signal 621. The measurement signal 621 is indicative of the thermal conductivity of the gas atmosphere in the battery 610. For example, the thermal conductivity sensor 620 may be implemented like the thermal conductivity sensor 500 described above with respect to FIG. 5. However, the present disclosure is not limited thereto. Other types of thermal conductivity sensors may be used as well.

The vehicle 600 further comprises an apparatus 630 for detecting a first venting event of the battery 610 according to the present disclosure. For example, the apparatus 630 may be configured as described above for the apparatus 100. The apparatus 630 is coupled to the thermal conductivity sensor 620 and is configured to receive the measurement signal 621.

The apparatus 630 allows to monitor the status of the battery 610 and determine the occurrence of a first venting event of the battery 610. The detection of a first venting event of the battery 610 allows for early detection of a thermal runaway event of the battery 610. The information about the first venting event may be used for preventing undesired situations in the cabin of the vehicle. For example, the vehicle 600 may comprise vehicle control circuitry 640 coupled to the apparatus 630. The vehicle control circuitry may, e.g., be configured to execute a vehicle safety routine if it is determined that the first venting event occurred. The vehicle safety routine may, e.g., comprise at least causing output of a warning for a user of the vehicle 600 by the vehicle 600 (such as an acoustic or optical warning). Accordingly, the user may be warned and leave the vehicle 600 before the thermal runaway event of the battery 610 takes place. It is to be noted that the vehicle safety routine may comprise additional, less or different measures such as, e.g., stopping the vehicle 600 or sending one or more warning messages to a respective receiving device of one or more of an owner of the vehicle 600, a (nearby) fire department and a manufacturer of the vehicle 600.

In the example of FIG. 6, the apparatus 630 and the thermal conductivity sensor 620 are separate elements-one arranged within the housing of the battery 610 and the other arranged outside the battery 610. However, the present disclosure is not limited thereto. In other examples, also the apparatus 630 may be arranged within the housing of the battery 610. Similarly, the apparatus 630 may be integrated into the thermal conductivity sensor 620 to provide a compact system (e.g., as additional circuitry integrated into a conventional thermal conductivity sensor).

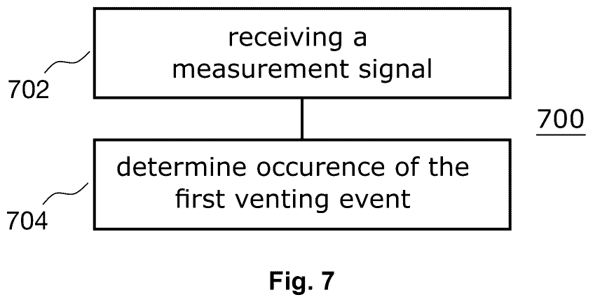

A flowchart of an example method 700 for detecting a first venting event of a battery is illustrated in FIG. 7. The method 700 comprises receiving 702 a measurement signal indicative of a thermal conductivity of a gas atmosphere in the battery. Additionally, the method 700 comprises determining 704 occurrence of the first venting based on the measurement signal.

The method 700 allows to detect the occurrence of a first venting event of the battery based on the measured thermal conductivity of the gas atmosphere in the battery. The detection of a first venting event of the battery allows for early detection of a thermal runaway event.

More details and aspects of the method 700 are explained in connection with the proposed technique or one or more example described above. The method 700 may comprise one or more additional optional features corresponding to one or more aspects of the proposed technique, or one or more example described above.

### ASPECTS

The aspects described herein may be summarized as follows:
Aspect 1 is an apparatus for detecting a first venting event of a battery. The apparatus comprises interface circuitry configured to receive a measurement signal indicative of a thermal conductivity of a gas atmosphere in the battery. Additionally, the apparatus comprises processing circuitry configured to determine occurrence of the first venting based on the measurement signal.
Aspect 2 is the apparatus of Aspect 1, wherein, for determining occurrence of the first venting event, the processing circuitry is configured to: determine a variation over time of the thermal conductivity of the gas atmosphere based on the measurement signal; and determine that the first venting event occurred if the variation over time of the thermal conductivity of the gas atmosphere satisfies a criterion.
Aspect 3 is the apparatus of Aspect 2, wherein the processing circuitry is configured to determine that the first venting event occurred if the variation over time of the thermal conductivity of the gas atmosphere changes by more than a threshold value.
Aspect 4 is the apparatus of Aspect 2 or Aspect 3, wherein the processing circuitry is configured to determine a standard deviation of a number of measurement values represented by the measurement signal as the variation over time of the thermal conductivity of the gas atmosphere.
Aspect 5 is the apparatus of Aspect 4, wherein the number of measurement values cover a measurement period of at least 100 milliseconds.
Aspect 6 is the apparatus of Aspect 4 or Aspect 5, wherein the number of measurement values cover a measurement period of not more than 10 seconds.
Aspect 7 is the apparatus of Aspect 2 or Aspect 3, wherein, for determining the variation over time of the thermal conductivity of the gas atmosphere, the processing circuitry is configured to: filter the measurement signal to obtain an auxiliary conductivity value representing a long-term thermal conductivity of the gas atmosphere; determine a difference value indicating a difference between a measurement value represented by the measurement signal and the auxiliary conductivity value; and determine a quotient of the difference value and the auxiliary conductivity value as the variation over time of the thermal conductivity of the gas atmosphere.
Aspect 8 is the apparatus of Aspect 7, wherein, for obtaining the auxiliary conductivity value, the processing circuitry is configured to average measurement values represented by the measurement signal.
Aspect 9 is the apparatus of any one of Aspects 2 to 8, wherein the processing circuitry is configured to perform signal conditioning processing on the measurement signal prior to determining the variation over time of the thermal conductivity of the gas atmosphere.
Aspect 10 is a system comprising an apparatus for detecting a first venting event of a battery according to any one of Aspects 1 to 9. The system further comprises a thermal conductivity sensor configured to measure the thermal conductivity of the gas atmosphere in the battery and to generate the measurement signal.
Aspect 11 is the system of Aspect 10, wherein the apparatus is integrated into the thermal conductivity sensor.
Aspect 12 is the system of Aspect 11, wherein the apparatus and the thermal conductivity sensor are separate elements.
Aspect 13 is a vehicle comprising a system according to any one of Aspects 10 to 12 and the battery.
Aspect 14 is the vehicle of Aspect 13, further comprising vehicle control circuitry configured to execute a vehicle safety routine if it is determined that the first venting event occurred.
Aspect 15 is the vehicle of Aspect 14, wherein the vehicle safety routine comprises at least causing output of a warning for a user by the vehicle.
Aspect 16 is the vehicle of any one of Aspects 13 to 15, wherein the thermal conductivity sensor is arranged within a housing of the battery.
Aspect 17 is a method for detecting a first venting event of a battery. The method comprises receiving a measurement signal indicative of a thermal conductivity of a gas atmosphere in the battery. Additionally, the method comprises determining occurrence of the first venting based on the measurement signal.

The aspects and features described in relation to a particular one of the previous aspects may also be combined with one or more of the further aspects to replace an identical or similar feature of that further aspect or to additionally introduce the features into the further aspect.

Aspects may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Aspects may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other aspects may also include computers, processors, control units, (field) programmable logic arrays ((F) PLAs), (field) programmable gate arrays ((F) PGAs), graphics processor units (GPU), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further aspects, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate aspect. It should also be noted that although in the claims a dependent claim refers to a particular combination with one or more other claims, other aspects may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. An apparatus for detecting a first venting event of a battery, comprising:
interface circuitry configured to receive a measurement signal indicative of a thermal conductivity of a gas atmosphere in the battery; and
processing circuitry configured to determine an occurrence of the first venting event based on the measurement signal.

2. The apparatus of claim 1, wherein, to determine the occurrence of the first venting event, the processing circuitry is configured to:
determine a variation over time of the thermal conductivity of the gas atmosphere based on the measurement signal; and
determine that the first venting event occurred if the variation over time of the thermal conductivity of the gas atmosphere satisfies a criterion.

3. The apparatus of claim 2, wherein the processing circuitry is configured to:
determine that the first venting event occurred if the variation over time of the thermal conductivity of the gas atmosphere changes by more than a threshold value.

4. The apparatus of claim 2, wherein the processing circuitry is configured to:
determine a standard deviation of a number of measurement values represented by the measurement signal as the variation over time of the thermal conductivity of the gas atmosphere.

5. The apparatus of claim 4, wherein the number of measurement values cover a measurement period of at least 100 milliseconds.

6. The apparatus of claim 5, wherein the number of measurement values cover a measurement period of not more than 10 seconds.

7. The apparatus of claim 2, wherein, to determine the variation over time of the thermal conductivity of the gas atmosphere, the processing circuitry is configured to:
filter the measurement signal to obtain an auxiliary conductivity value representing a long-term thermal conductivity of the gas atmosphere;
determine a difference value indicating a difference between a measurement value represented by the measurement signal and the auxiliary conductivity value; and
determine a quotient of the difference value and the auxiliary conductivity value as the variation over time of the thermal conductivity of the gas atmosphere.

8. The apparatus of claim 7, wherein, to obtain the auxiliary conductivity value, the processing circuitry is configured to;
average measurement values represented by the measurement signal.

9. The apparatus of claim 2, wherein the processing circuitry is configured to:
perform signal conditioning processing on the measurement signal prior to determining the variation over time of the thermal conductivity of the gas atmosphere.

10. The apparatus of claim 1, further comprising:
a thermal conductivity sensor configured to:
measure the thermal conductivity of the gas atmosphere in the battery; and
generate the measurement signal.

11. The apparatus of claim 10, wherein the apparatus is integrated into the thermal conductivity sensor.

12. The apparatus of claim 11, wherein the apparatus and the thermal conductivity sensor are separate elements.

13. A vehicle, comprising:
a system comprising:
an apparatus configured to detect a first venting event of a battery, the apparatus comprising:
interface circuitry configured to receive a measurement signal indicative of a thermal conductivity of a gas atmosphere in the battery;
processing circuitry configured to determine an occurrence of the first venting event based on the measurement signal;
a thermal conductivity sensor configured to:
measure the thermal conductivity of the gas atmosphere in the battery; and
generate the measurement signal;
and
the battery.

14. The vehicle of claim 13, further comprising:
vehicle control circuitry configured to execute a vehicle safety routine based on determining an occurrence of the first venting event.

15. The vehicle of claim 14, wherein the vehicle control circuitry, to execute the vehicle safety routine, is configured to:
cause a warning to be output by the vehicle.

16. The vehicle of claim 13, wherein the thermal conductivity sensor is arranged within a housing of the battery.

17. A method for detecting a first venting event of a battery, comprising:
receiving a measurement signal indicative of a thermal conductivity of a gas atmosphere in the battery; and
determining an occurrence of the first venting event based on the measurement signal.

18. The method of claim 17, wherein determining the occurrence of the first venting event comprises:
determining a variation over time of the thermal conductivity of the gas atmosphere based on the measurement signal; and
determining the occurrence of the first venting event based on the variation over time of the thermal conductivity of the gas atmosphere satisfying a criterion.

19. The method of claim 18, wherein determining the occurrence of the first venting event further comprises:
determining the occurrence of the first venting event based on the variation over time of the thermal conductivity of the gas atmosphere changes by more than a threshold value.

20. The method of claim 18, wherein determining the variation over time comprises:
determining a standard deviation of a number of measurement values represented by the measurement signal.
